(19) United States
(12) Patent Application Publication
(10) Pub. No.: US 2009/0162576 A1
(43) Pub. Date: Jun. 25, 2009

(54) LIQUID CRYSTAL COMPOSITION AND LIQUID CRYSTAL DISPLAY HAVING THE SAME

(76) Inventors: Jun-hyup Lee, Seoul (KR); Nam-seok Lee, Suwon-si (KR); Su-jung Huh, Yongin-si (KR); Duck-jong Suh, Seoul (KR)

Correspondence Address: Frank Chau, Esq.;F. CHAU & ASSOCIATES, LLC, 130 Woodbury Road, Woodbury, NY, 11797, US

(21) Appl. No.: 12/147,278

(22) Filed: Jun. 26, 2008

(30) Foreign Application Priority Data
Dec. 24, 2007 (KR) 10-2007-0136433

(51) Int. Cl. C09K 19/32

(52) U.S. Cl. 428/1.6; 252/299.63

(57) ABSTRACT

A liquid crystal composition includes both high dielectric anisotropy and low rotational viscosity. Therefore, a liquid crystal display (LCD) device comprising the liquid crystal composition may have an improved response time and may be capable of being driven at low voltage.

### CROSS-REFERENCE TO RELATED APPLICATIONS

This application claims priority from Korean Patent Application No. 10-2007-0136433, filed on Dec. 24, 2007, the disclosure of which is hereby incorporated by reference herein in its entirety.

### BACKGROUND OF INVENTION

1. Technical Field

The present invention relates to a liquid crystal composition and a liquid crystal display having the same.

2. Description of Related Art

A liquid crystal display (LCD) e typically includes a first substrate, a second substrate, and a liquid crystal layer disposed between the substrates. The two substrates form an electric field. The liquid crystal layer is formed of a liquid crystal composition and selective additives.

The LCD is being used for large-sized display devices such as television sets. Moreover, recently, the viewing angle, color reproducibility, and brightness of LCDs have improved considerably. However, the response time of the LCD still needs further improvement.

The LCD is also being employed for portable electronic equipment such as a notebook, which requires driving at a low voltage level.

The response time of the LCD is closely related to the rotational viscosity of a liquid crystal composition. For example, when the liquid crystal composition has a low rotational viscosity, the LCD has a shorter response time. Meanwhile, the driving voltage required for the LCD is closely connected with the dielectric anisotropy of the liquid crystal composition. Namely, when the liquid crystal composition has a high dielectric anisotropy, the LCD can be driven at a low voltage level.

Thus, a liquid crystal composition with a low rotational viscosity and high dielectric anisotropy is desirable to improve the response time and to be driving at a low voltage level.

However, liquid crystal molecules forming a liquid crystal composition generally have high rotational viscosity when dielectric anisotropy thereof is high. Thus, it may not be easy to improve the response time of the LCD device and drive the device at low voltage at the same time.

### SUMMARY OF INVENTION

In accordance with an exemplary embodiment of the present invention, a liquid crystal composition is provided. The liquid Crystal composition includes about 1 to about 15% of at least one Compound 1 represented by Chemical formula 1, about 30 to about 50% of at least one Compound 2 represented by Chemical formula 2, about 5 to about 20% of at least one Compound 3 represented by Chemical formula 3, about 4 to about 12% of at least one Compound 4 represented by Chemical formula 4, about 10 to about 20% of at least one Compound 5 represented by Chemical formula 5, about 0 to about 20% of at least one Compound 6 represented by Chemical formula 6, and about 4 to about 20% of at least one Compound 7 represented by Chemical formula 7:

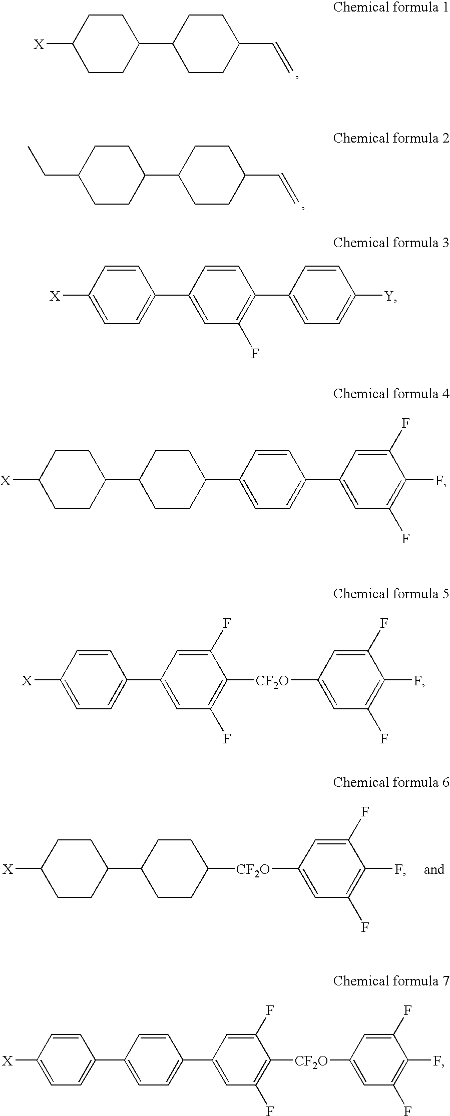

in the formulas, X represents a C3 to C5 aliphatic group, and Y represents a C1 or C2 aliphatic group.

The liquid crystal composition may have a phase transition temperature of about 70° C. to about 80° C., a refractive anisotropy of about 0.11 to about 0.12, a dielectric anisotropy of about 7 to about 9, and a rotational viscosity of about 55 mPa·s to about 70 mPa·s.

The liquid crystal composition may include about 1 to about 5% of at least one Compound 1 represented by Chemical formula 1, about 35 to about 45% of at least one Compound 2 represented by Chemical formula 2, about 14 to about 18% of at least one Compound 3 represented by Chemical formula 3, about 4 to about 8% of at least one Compound 4 represented by Chemical formula 4, about 10 to about 15% of at least one Compound 5 represented by Chemical formula 5, about 10 to about 18% of at least one Compound 6 represented by Chemical formula 6, and about 8 to about 10% of at least one Compound 7 represented by Chemical formula 7.

The liquid crystal composition may have a phase transition temperature of about 74.0° C. to about 76.0° C., a refractive anisotropy of about 0.11 to about 0.12, a dielectric anisotropy of about 8.0 to about 8.5, and a rotational viscosity of about 60 mPa·s to about 65 mPa·s.

In accordance with an exemplary embodiment of the present invention, a liquid crystal display device is provided. The liquid crystal display device includes a first substrate including a thin film transistor and a pixel electrode electrically connected to the thin film transistor, a second substrate facing the first substrate and including a common electrode and a liquid crystal layer disposed between the first substrate and the second substrate and a liquid crystal composition in the liquid crystal layer. The liquid crystal composition includes about 1 to about 15% of at least one Compound 1 represented by Chemical formula 1, about 30 to about 50% of at least one Compound 2 represented by Chemical formula 2, about 5 to about 20% of at least one Compound 3 represented by Chemical formula 3, about 4 to about 12% of at least one Compound 4 represented by Chemical formula 4, about 10 to about 20% of at least one Compound 5 represented by Chemical formula 5, about 0 to about 20% of at least one Compound 6 represented by Chemical formula 6, and about 4 to about 20% of at least one Compound 7 represented by Chemical formula 7:

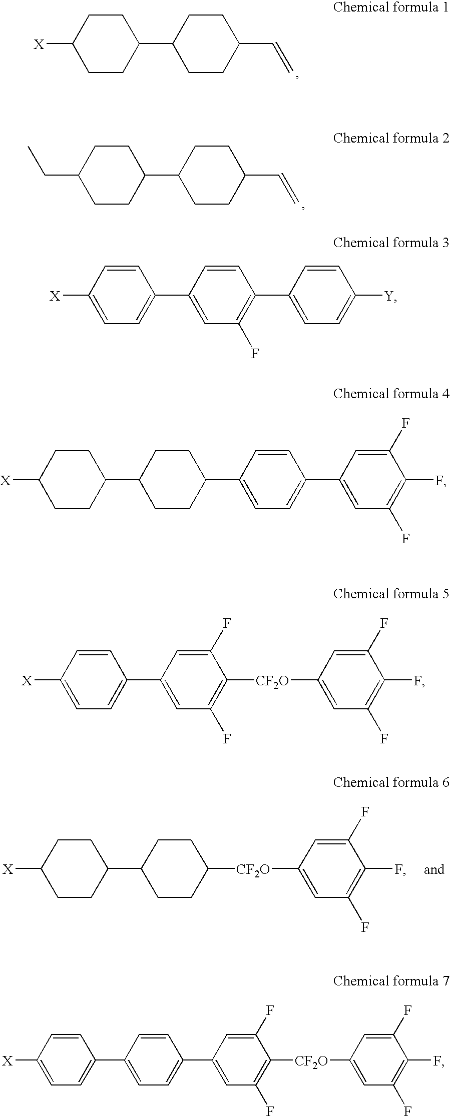

in the formulas, X represents a C3 to C5 aliphatic group, and Y represents a C1 to C2 aliphatic group.

The liquid crystal composition may have a phase transition temperature of about 70° C. to about 80° C., a refractive anisotropy of about 0.11 to about 0.12, a dielectric anisotropy of about 7 to about 9, and a rotational viscosity of about 55 mPa·s to about 70 mPa·s.

A cell gap may be about 2.5 μm to about 3.7 μm.

A driving voltage of the liquid crystal display may be about 8.0V to about 13.0V.

The liquid crystal composition may include about 1 to about 5% of at least one Compound 1 represented by Chemical formula 1, about 35 to about 45% of at least one Compound 2 represented by Chemical formula 2, about 14 to about 18% of at least one Compound 3 represented by Chemical formula 3, about 4 to about 8% of at least one Compound 4 represented by Chemical formula 4, about 10 to about 15% of at least one Compound 5 represented by Chemical formula 5, about 10 to about 18% of at least one Compound 6 represented by Chemical formula 6, and about 8 to about 10% of at least one Compound 7 represented by Chemical formula 7.

The liquid crystal composition may have a phase transition temperature of about 74.0° C. to about 76.0° C., a refractive anisotropy of about 0.11 to about 0.12, a dielectric anisotropy of about 8.0 to about 8.5, and a rotational viscosity of about 60 mPa·s to about 65 mPa·s.

A cell gap may be about 3.5 μm to about 3.7 μm.

A driving voltage of the liquid crystal display may be about 8.3V to about 8.8V.

A black voltage may be about 8.0V to about 8.5V, and a white voltage may be about 0.5V to about 0.7V.

The liquid crystal layer may have a response time of about 8 ms to about 9 ms.

The liquid crystal layer may have a delay value of about 390 nm to about 440 nm.

A contrast ratio may be about 1000:1 to about 1200:1.

### BRIEF DESCRIPTION OF DRAWINGS

Exemplary embodiments of the present invention can be understood in more detail from the following description, taken in conjunction with the accompanying drawings, in which:

FIG. 1 is a layout view of a first substrate in a liquid crystal display according to an exemplary embodiment of the present invention;

FIG. 2 is a cross-sectional view taken along line II-II in FIG. 1;

FIG. 3 is a graph to illustrate a response time according to a cell gap in a liquid crystal composition according to an exemplary embodiment of the present invention;

FIG. 4 is a graph to illustrate a response time according to a driving voltage in a liquid crystal composition according to an exemplary embodiment of the present invention; and

FIG. 5 is a graph to illustrate a response time according to a white voltage in the liquid crystal composition according to an exemplary embodiment of the present invention.

### DETAILED DESCRIPTION OF EXEMPLARY EMBODIMENTS OF INVENTION

Reference will now be made in detail to the embodiments of the present invention, examples of which are illustrated in the accompanying drawings, wherein like reference numerals refer to like elements throughout.

In the following description, if a layer is said to be formed ‘on’ another layer, a third layer may be disposed between the two layers or the two layers may be in contact with each other. In other words, it will be understood that when an element such as a layer, film, region, or substrate is referred to as being “on” another element, it can be directly on the other element or intervening elements may also be present.

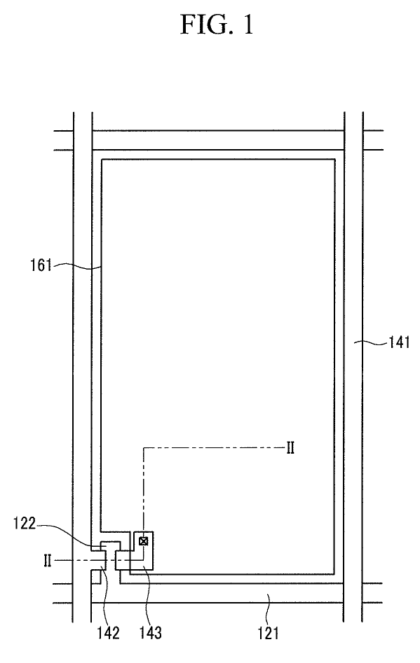

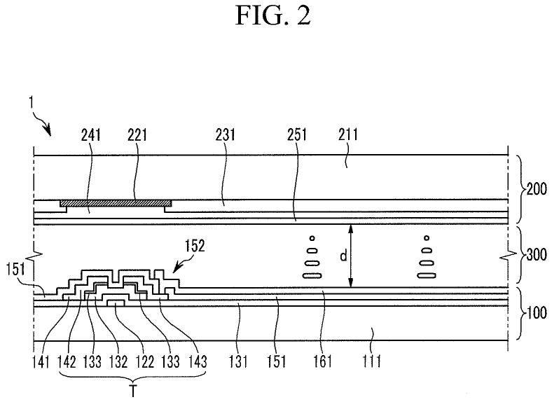

A liquid crystal display according to an exemplary embodiment of the present invention will be described with reference to FIGS. 1 and 2.

FIG. 1 is a layout view of a first substrate in a liquid crystal display according to an exemplary embodiment of the present invention, and FIG. 2 is a cross-sectional view taken along line II-II in FIG. 1.

The liquid crystal display 1 includes a first substrate 100 where thin film transistors (T) are formed, a second substrate 200 facing the first substrate 100, and a liquid crystal layer 300 disposed between the substrates 100 and 200.

First of all, the first substrate 100 will be described.

A gate wiring 121 and 122 is formed on a first insulating substrate 111. The gate wiring 121 and 122 may be a metal single layer or a metal multilayer. The gate wiring 121 and 122 includes a plurality of gate lines 121 disposed within a display region and extending transversely and a plurality of gate electrodes 122 connected to each gate line 121.

A gate insulating layer 131 made of, for example, silicon nitride (SiNx) or the like is formed on the first insulating substrate 111 to cover the gate wiring 121 and 122.

A semiconductor layer 132 made of, for example, amorphous silicon is formed on the gate insulating layer 131 over the gate electrodes 122. An ohmic contact layer 133 made of, for example, hydrogenated amorphous silicon highly doped with n-type impurities is formed on the semiconductor layer 132. The ohmic contact layer 133 is removed in a channel area between a source electrode 142 and a drain electrode 143.

A data wiring 141, 142, and 143 is formed on the ohmic contact layer 133 and the exposed gate insulating layer 131. The data wiring 141, 142, and 143 may be a metal single layer or a metal multilayer.

The data wiring 141, 142, and 143 includes a plurality of data lines 141 formed lengthwise to intersect the gate lines 121 to form pixels, the source electrodes 142 branched from each data line 141 and extended over the ohmic contact layer 133, and the drain electrodes 143 separated from the source electrodes 142 and formed on a portion of the ohmic contact layer 133 opposite to the source electrodes 142.

A passivation layer 151 is formed on the data wiring 141, 142, and 143 and a portion of the semiconductor layer 132 not covered with the data wiring 141, 142, and 143. The passivation layer 151 is formed with a plurality of contact holes 152 to expose the drain electrodes 143.

A plurality of pixel electrodes 161 are formed on the passivation layer 151. The pixel electrodes 161 are generally made of a transparent conductive material such as, for example, indium tin oxide (ITO) or indium zinc oxide (IZO).

The configuration of the first substrate 100 according to exemplary embodiments of the present invention is not limited to the aforementioned. The first substrate 100 may have various modifications, e.g., a semiconductor layer 132 of poly silicon or a top-gate type TFT.

Next, the second substrate 200 will be described.

A black matrix 221 is formed on a second insulating substrate 211. The black matrix 221 prevents light from being irradiated directly to the thin film transistors on the first substrate 100. The black matrix 221 is typically made of, for example, a photoresist organic material including a black pigment. The black pigment may be, for example, carbon black.

A color filter layer 231 includes red, green and blue filters which are alternately disposed and separated by the black matrix 221. The color filter layer 231 endows colors to light irradiated from a backlight unit and passing through the liquid crystal layer 300. The color filter layer 231 is generally made of, for example, a photoresist organic material.

An overcoat layer 241 is formed on the color filter layer 231 and a portion of the black matrix 221 not covered with the color filter layer 231. The overcoat layer 241 provides a planar surface and protects the color filter layer 231. The overcoat layer 241 may be formed of, for example, photoresist acrylic resin.

A common electrode 251 is formed on the overcoat layer 241. The common electrode 251 is made of a transparent conductive material such as, for example, ITO or IZO. The common electrode 251 applies a voltage to the liquid crystal layer 300 along with the pixel electrodes 161 of the first substrate 100.

The liquid crystal layer 300 is disposed between the first substrate 100 and the second substrate 200. The liquid crystal layer 300 is twisted nematic mode, in which liquid crystal molecules in the liquid crystal layer 300 being twisted at about 90 degrees by alignment films (not shown) formed on the first substrate 100 and the second substrate 200. The liquid crystal molecules are arranged with their long axes vertical to the substrates 100 and 200 when a vertical electric field is formed between the first substrate 100 and the second substrate 200.

In the present exemplary embodiment, the liquid crystal display 1 is in the normally white mode, which displays white by passing through light in a voltage-off state, in which a voltage is not applied to a pixel and displays black by blocking light when a vertical electric field is formed between the first substrate 100 and the second substrate 200.

The liquid crystal layer 300 of the present invention includes a liquid crystal composition explained below, further including known additives if necessary. The additives may include, for example, dyes, a UV stabilizer, and/or an antioxidant. In the following, it is considered that the liquid crystal composition and the liquid crystal layer 300 have the same properties.

The liquid crystal composition includes the following elements. The term “percent (%)” mentioned below indicates weight percent.

At least one Compound 1 represented by Chemical formula 1: about 1 to about 15%

At least one Compound 2 represented by Chemical formula 2: about 30 to about 50%

At least one Compound 3 represented by Chemical formula 3: about 5 to about 20%

At least one Compound 4 represented by Chemical formula 4: about 4 to about 12%

At least one Compound 5 represented by Chemical formula 5: about 10 to about 20%

At least one Compound 6 represented by Chemical formula 6: about 0 to about 20%

At least one Compound 7 represented by Chemical formula 7: about 4 to about 20%

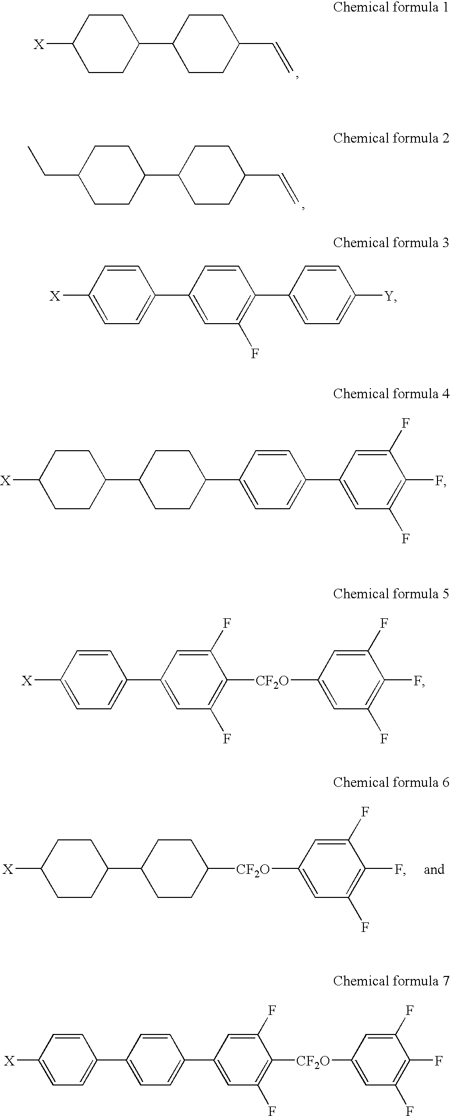

In the formulas, X represents a C3 to C5 aliphatic group, and Y represents a C1 or C2 aliphatic group.

Here, when Compound 7 is more than about 15%, the stability of the liquid crystal composition at low temperature may be deteriorated. Thus, the amount of Compound 7 may be limited to about 4 to about 15% if necessary.

Compounds 1 to 3 are a non-polar substance, and Compounds 4 to 7 are a polar substance.

Here, Compound 2 has a very low rotational viscosity and low dielectric anisotropy. On the other hand, Compound 7 has a very high dielectric anisotropy of about 20 to about 40. Thus, the use of Compound 7 enables the dielectric anisotropy of the liquid crystal composition to be kept high although the amount of Compound 2 is increased. Further, because of the increase of Compound 2 in amount, the liquid crystal composition has a low rotational viscosity.

Due to actions of Compound 2 and Compound 7, the liquid crystal composition has a high dielectric anisotropy and low rotational viscosity, thereby achieving a low-voltage driving and short response time for the liquid crystal display.

Meanwhile, as Compound 7 has a very high phase transition temperature of about 70° C. to about 160° C., the liquid crystal composition also has a high phase transition temperature.

The aforementioned liquid crystal composition has a phase transition temperature of about 70° C. to about 80° C., a refractive anisotropy of about 0.11 to about 0.12, a dielectric anisotropy of about 7 to about 9, and a rotational viscosity of about 55 mPa·s to about 70 mPa·s. The LCD device 1 has a cell gap d (in FIG. 2) of about 2.5 μm to about 3.7 μm.

As the liquid crystal composition has a high dielectric anisotropy, a driving voltage (AVDD) may be kept low. The driving voltage may be about 8.0V to about 13.0V, For example, the driving voltage may be about 8.0V to about 10.0V.

Meanwhile, the liquid crystal composition has a relatively short response time of about 7.0 ms to about 10.0 ms under the conditions of its aforementioned properties, and the cell gap and driving voltage of the liquid crystal display 1.

Liquid crystal compositions with different compositions are measured regarding properties and response times through experiments.

Three kinds of liquid crystal compositions according to Examples 1 to 3 are used in the experiments.

The compositions according to Examples 1 to 3 are given in Table 1.

TABLE 1
Unit: %

| | Example 1 | Example 2 | Example 3 |
|---|---|---|---|
| Compound 1 | 4 | 2 | 13 |
| Compound 2 | 39 | 41 | 43 |
| Compound 3 | 15 | 16 | 10 |
| Compound 4 | 9 | 6 | 6 |
| Compound 5 | 16 | 12 | 13 |
| Compound 6 | 11 | 14 | 0 |
| Compound 7 | 6 | 9 | 15 |

The liquid crystal compositions according to Examples have the following properties in Table 2.

TABLE 2

| | Example 1 | Example 2 | Example 3 |
|---|---|---|---|
| Phase Transition | 74.9 | 75.0 | 75.2 |
| Temperature | | | |
| (Tni, ° C.) | | | |
| Δn | 0.114 | 0.115 | 0.114 |
| Δε | 8.5 | 8.3 | 8.3 |
| γ1 | 63.6 | 63.0 | 59.7 |
| (mPa · s) | | | |
| Response Time | 8.4 | 8.3 | 7.9 |
| (ms) | | | |

In Table 2, Δn is optical anisotropy (at about 20° C., about 589 nm), Δ∈ is dielectric anisotropy (at about 20° C.), and γ1 is rotational viscosity (at about 20° C.) Here, the response times in Table 2 are obtained under a driving voltage of about 8V and a cell gap of about 3.6 μm.

The response time of a liquid crystal composition is determined by the sum of a rising time (Ton) and a falling time (Toff). When the response time of liquid crystals is long, motion blur may occur to thereby deteriorate the quality of a display.

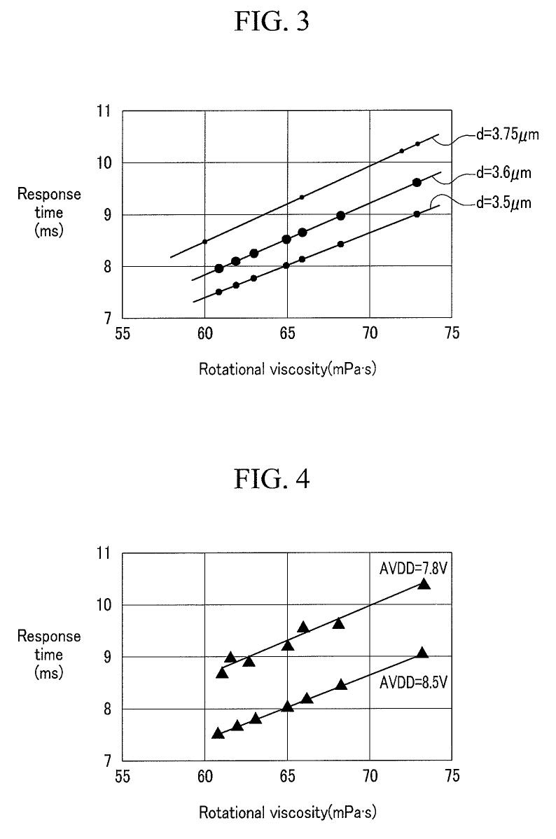

Meanwhile, experiments are carried out to find a specific liquid crystal composition, cell gap, and a driving condition satisfying the required conditions of a response time of about 9 ms or less and a driving voltage of about 9V or less, as shown in FIGS. 3 to 5.

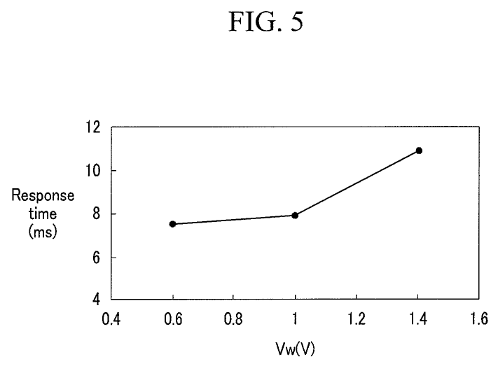

FIG. 3 shows graphs to illustrate a response time according to a cell gap in a liquid crystal composition according to an exemplary embodiment of the present invention, FIG. 4 is a graph to illustrate a response time according to a driving voltage in a liquid crystal composition according to an exemplary embodiment of the present invention, and FIG. 5 is a graph to illustrate a response time according to a white voltage in the liquid crystal composition according to an exemplary embodiment of the present invention.

First, experiments on cell gap and a driving condition are carried out with liquid crystal compositions having different rotational viscosities according to exemplary embodiments of the present invention.

<Experiment of Cell Gap>

FIG. 3 illustrates the results of response times according to cell gaps under a driving voltage (AVDD) of about 8.5V.

In a cell gap of about 3.5 μm, a response time is the shortest. In a cell gap of about 3.75 μm, it may not be easy to obtain a response time of about 9 ms or less. When the cell gap is less than about 3.5 μm, productivity may be decreased. Thus, the cell gap is preferably about 3.5 μm or more.

<Experiment of Driving Voltage>

FIG. 4 illustrates the results of response times according to driving voltages under a cell gap of about 3.5 μm.

When a driving voltage is low, e.g., about 7.8V, it may not be easy to obtain a response time of about 9 ms or less.

Next, experiments are carried out with the liquid crystal composition of Example 2 to get a white voltage (Vw) that is a voltage applied to a pixel for displaying white and a black voltage (Vb) that is a voltage applied to a pixel for displaying black.

<Experiment of White Voltage>

FIG. 5 illustrates the results of response times according to white voltages under a cell gap of about 3.5 μm. When a white voltage is low, e.g., about 0.6V, a short response time can be obtained.

<Experiment of Black Voltage>

Response times are measured according to white voltages under a cell gap of about 3.5 μm. When a black voltage is about 7.8V, a response time is comparatively long, e.g., about 8.72 ms. When a black voltage is about 8.0V, a response time is about 8.44 ms.

Based on the foregoing experimental results, optimal conditions of a liquid crystal composition, cell gap, and driving condition are established as follows to stably satisfy both a response time of about 9 ms or less and a driving voltage of about 9V or less.

<Optimal Conditions>

Liquid crystal composition: liquid crystal composition of Example 2

Cell gap: about 3.6 μm

Cell delay value (Δnd): about 414 nm

AVDD: about 8.5V

Black voltage: about 8.0V

White voltage: about 0.6V

Under the foregoing condition, the LCD device 1 has a response time of about 8.39 ms and a contrast ratio of about 1100:1. Moreover, the device passes a standard in reliability tests at high temperature and low temperature and an after-image test.

The foregoing optimal conditions may be modified for practical use to satisfy a response time of about 8 ms to about 9 ms. Specific variations are as follows.

A liquid crystal composition according to Example 2 has the following configuration and properties.

At least one Compound 1 represented by Chemical formula 1: about 1 to about 5%

At least one Compound 2 represented by Chemical formula 2: about 35 to about 45%

At least one Compound 3 represented by Chemical formula 3: about 14 to about 18%

At least one Compound 4 represented by Chemical formula 4: about 4 to about 8%

At least one Compound 5 represented by Chemical formula 5: about 10 to about 15%

At least one Compound 6 represented by Chemical formula 6: about 10 to about 18%

At least one Compound 7 represented by Chemical formula 7: about 8 to about 10%

Cell gap: about 3.5 μm to about 3.7 μm

Cell delay value (Δnd): about 390 nm to about 440 nm

AVDD: about 8.3V to about 8.8V

Black voltage: about 8.0V to about 8.5V

White voltage: about 0.5V to about 0.7V

Here, the liquid crystal composition has a phase transition temperature of about 74.0° C. to about 76.0° C., a refractive anisotropy of about 0.11 to about 0.12, a dielectric anisotropy of about 8 to about 8.5, and a rotational viscosity of about 60 mPa·s to about 65 mPa·s.

As described above, exemplary embodiments of the present invention provide a liquid crystal composition having both high dielectric anisotropy and low rotational viscosity.

Further, exemplary embodiments of the present invention provide a LCD device having an improved response time and which is capable of being driven at low voltage.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A liquid crystal composition comprising:
about 1 to about 15% of at least one Compound 1 represented by Chemical formula 1,
about 30 to about 50% of at least one Compound 2 represented by Chemical formula 2,
about 5 to about 20% of at least one Compound 3 represented by Chemical formula 3,
about 4 to about 12% of at least one Compound 4 represented by Chemical formula 4,
about 10 to about 20% of at least one Compound 5 represented by Chemical formula 5,
about 0 to about 20% of at least one Compound 6 represented by Chemical formula 6, and
about 4 to about 20% of at least one Compound 7 represented by Chemical formula 7: 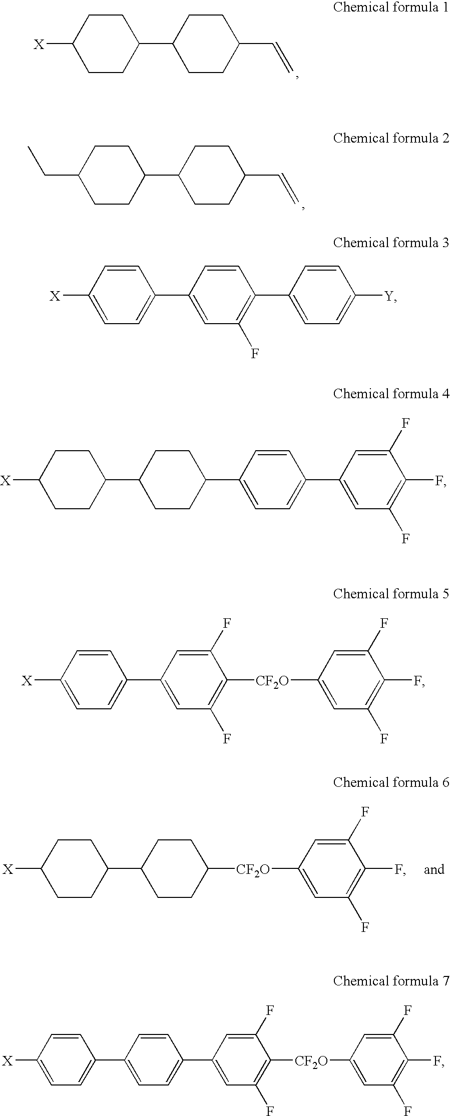
in the formulas, X represents a C3 to C5 aliphatic group, and Y represents a C1 or C2 aliphatic group.

2. The liquid crystal composition of claim 1, wherein the liquid crystal composition has a phase transition temperature of about 70° C. to about 80° C., a refractive anisotropy of about 0.11 to about 0.12, a dielectric anisotropy of about 7 to about 9, and a rotational viscosity of about 55 mPa·s to about 70 mPa·s.

3. The liquid crystal composition of claim 1, comprising
about 1 to about 5% of at least one Compound 1 represented by Chemical formula 1,
about 35 to about 45% of at least one Compound 2 represented by Chemical formula 2,
about 14 to about 18% of at least one Compound 3 represented by Chemical formula 3,
about 4 to about 8% of at least one Compound 4 represented by Chemical formula 4,
about 10 to about 15% of at least one Compound 5 represented by Chemical formula 5,
about 10 to about 18% of at least one Compound 6 represented by Chemical formula 6, and
about 8 to about 10% of at least one Compound 7 represented by Chemical formula 7.

4. The liquid crystal composition of claim 3, wherein the liquid crystal composition has a phase transition temperature of about 74.0° C. to about 76.0° C., a refractive anisotropy of about 0.11 to about 0.12, a dielectric anisotropy of about 8.0 to about 8.5, and a rotational viscosity of about 60 mPa·s to about 65 mPa·s.

5. A liquid crystal display comprising:
a first substrate comprising a thin film transistor and a pixel electrode electrically connected to the thin film transistor;
a second substrate facing the first substrate and comprising a common electrode; and
a liquid crystal layer disposed between the first substrate and the second substrate,
a liquid crystal composition in the liquid crystal layer comprising
about 1 to about 15% of at least one Compound 1 represented by Chemical formula 1,
about 30 to about 50% of at least one Compound 2 represented by Chemical formula 2,
about 5 to about 20% of at least one Compound 3 represented by Chemical formula 3,
about 4 to about 12% of at least one Compound 4 represented by Chemical formula 4,
about 10 to about 20% of at least one Compound 5 represented by Chemical formula 5,
about 0 to about 20% of at least one Compound 6 represented by Chemical formula 6, and
about 4 to about 20% of at least one Compound 7 represented by Chemical formula 7: 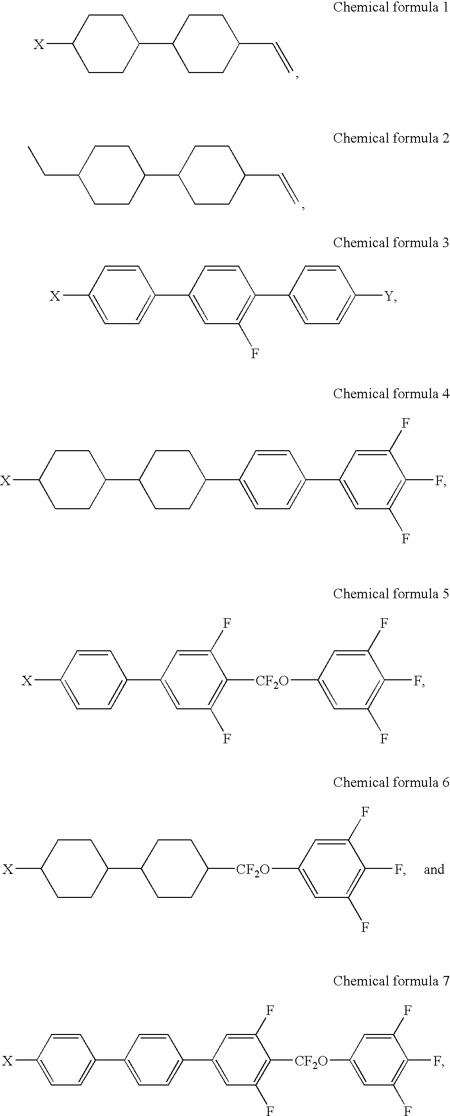
in the formulas, X represents a C3 to C5 aliphatic group, and Y represents a C1 to C2 aliphatic group.

6. The liquid crystal display of claim 5, wherein the liquid crystal composition has a phase transition temperature of about 70° C. to about 80° C., a refractive anisotropy of about 0.11 to about 0.12, a dielectric anisotropy of about 7 to about 9, and a rotational viscosity of about 55 mPa·s to about 70 mPa·s.

7. The liquid crystal display of claim 5, wherein a cell gap is about 2.5 μm to about 3.7 μm.

8. The liquid crystal display of claim 7, wherein a driving voltage of the liquid crystal display is about 8.0V to about 13.0V.

9. The liquid crystal display of claim 5, wherein the liquid crystal composition comprises
about 1 to about 5% of at least one Compound 1 represented by Chemical formula 1,
about 35 to about 45% of at least one Compound 2 represented by Chemical formula 2,
about 14 to about 18% of at least one Compound 3 represented by Chemical formula 3,
about 4 to about 8% of at least one Compound 4 represented by Chemical formula 4,
about 10 to about 15% of at least one Compound 5 represented by Chemical formula 5,
about 10 to about 18% of at least one Compound 6 represented by Chemical formula 6, and
about 8 to about 10% of at least one Compound 7 represented Chemical formula 7.

10. The liquid crystal display of claim 9, wherein the liquid crystal composition has a phase transition temperature of about 74.0° C. to about 76.0° C., a refractive anisotropy of about 0.11 to about 0.12, a dielectric anisotropy of about 8.0 to about 8.5, and a rotational viscosity of about 60 mPa·s to about 65 mPa·s.

11. The liquid crystal display of claim 9, wherein a cell gap is about 3.5 μm to about 3.7 μm.

12. The liquid crystal display of claim 9, wherein a driving voltage of the liquid crystal display is about 8.3V to about 8.8V.

13. The liquid crystal display of claim 12, wherein a black voltage is about 8.0V to about 8.5V, and a white voltage is about 0.5V to about 0.7V.

14. The liquid crystal display of claim 13, wherein the liquid crystal layer has a response time of about 8 ms to about 9 ms.

15. The liquid crystal display of claim 13, wherein the liquid crystal layer has a delay value of about 390 nm to about 440 nm.

16. The liquid crystal display of claim 13, wherein a contrast ratio is about 1000:1 to about 1200:1.
